(19) United States
(12) Patent Application Publication
(10) Pub. No.: US 2016/0352018 A1
(43) Pub. Date: Dec. 1, 2016

(54) ANTENNA

(71) Applicant: Harada Industry Co., Ltd., Tokyo (JP)

(72) Inventor: Dedimuni Rusiru Vinodaka LEELARATNE, Sittingbourne (GB)

(21) Appl. No.: 15/164,382

(22) Filed: May 25, 2016

(30) Foreign Application Priority Data
May 26, 2015 (GB) 1508934.5

(51) Int. Cl. H01Q 9/04; H01Q 1/38

(52) U.S. Cl. CPC H01Q 9/0457; H01Q 1/38; H01Q 1/3233

(57) ABSTRACT

A contactless feed patch antenna including a generally planar first conductive sheet provided as a ground plane, and a second conductive sheet provided as a radiative element. The second conductive sheet includes a generally planar first radiative region arranged substantially parallel with the first conductive sheet, and a second radiative region including a non-parallel portion arranged in a non-parallel plane to that of the first radiative region.

### CROSS-REFERENCE TO RELATED APPLICATION

This application claims priority under 35 U.S.C. §119(a) to Patent Application No. 1508934.5, filed in the United Kingdom on May 26, 2015, the entire contents of Application No. 1508934.5 are hereby incorporated herein by reference.

### FIELD OF THE INVENTION

The present invention relates to an improved patch antenna, in particular an improved contactless feed patch antenna.

### BACKGROUND OF THE INVENTION

Contactless feed patch antennas are known in the art. For example, they are routinely used in the automotive industry for antennas for GPS receivers, and digital radios. It is desirable to provide relatively small antennas to allow the antennas to be unobtrusively located within vehicles. It is also desirable to optimise the performance of such antennas.

### SUMMARY OF THE INVENTION

Accordingly, in an aspect, the present invention proposes a contactless feed patch antenna. Thus, a contactless feed patch antenna according to the present invention provides an antenna with a reduced footprint and compact size relative to the prior art antennas, because at least a portion of the second radiative region of the second conductive sheet is preferably arranged out of the plane of the first radiative region, thereby reducing the overall lateral extent of the antenna.

Furthermore, the arrangement of the first and second radiative regions provides an antenna with enhanced beamwidth allowing for better performance at low elevation angles. The second radiative region is preferably arranged at or outward of the periphery of the first radiative region. The non-parallel portion may extend only partway between the first radiative region and the ground plane.

One or more non-conducting regions are preferably provided in the second conductive sheet between the first radiative region and the second radiative region, the patch antenna thereby being configured to be operable as a multi-band patch antenna. The one or more non-conducting regions may be provided as one or more slits in the second conductive sheet.

The first radiative region may be provided in the general form of a quadrilateral, for example a rectangle or square. The first radiative region may be provided in the general form of a quadrilateral in which each corner, of one pair, or both pairs, of diagonally opposing corners of the quadrilateral, is chamfered. The chamfer may be an oblique truncation for example.

The second radiative region preferably includes a parallel portion arranged to be parallel with the first radiative region. The parallel portion is preferably coplanar with the first radiative region.

The second radiative region may include a fold provided between the parallel portion and the non-parallel portion. The non-parallel portion includes a plurality of sub-portions, each arranged around a respective side of the perimeter of the first radiative region.

Each of a pair of adjacent sub-portions are preferably chamfered so as to cooperate to define a chamfered region of the non-parallel portion, the chamfered region being associated with one of the chamfered corners of the first radiative region. For example, the chamfered region being located at the same corner of the antenna as a chamfered corner of the first radiative region.

The first and second radiative regions are preferably electrically connected by at least one bridging element. Each corner of the first radiative element is preferably electrically connected to a corresponding corner region of the second radiative element by a bridging element (e.g. by a respective bridging element of a plurality of bridging elements); and wherein each chamfered corner of the first radiative element is electrically connected to a corresponding chamfered region of the second radiative element.

The first radiative region is preferably formed to define a void therein. A correspondingly shaped electric feed element may be provided coaxially with the void to be physically separate from, but electrically coupled to, the first radiative region. For example, a correspondingly shaped electric feed element may be provided coaxially with the void to be physically separate from, but capacitively coupled to, the first radiative region. Advantageously, such a capacitively coupled feed provides for the inductance of the feed element to be cancelled out to allow for a perfect imaginary match, thereby improving the performance of the antenna.

The electric feed element is preferably located within the void. For example a portion of the electric fee element may be arranged to be coplanar with the first radiative element.

The second radiative region may include at least one tab element projecting from the parallel portion into the non-conducting region. The perimeter of the first radiative region may be shaped to include at least one recess for receiving the at least one tab element.

At least the first radiative region of the generally planar second conductive sheet is preferably arranged, e.g. mounted, on a substrate. At least the first radiative region of the generally planar second conductive sheet is sandwiched between the substrate and a superstrate. For example, the superstrate may be moulded onto an assembly comprising the substrate on which is arranged the generally planar second conductive sheet, for example at least the first radiative region thereof.

The non-parallel portion preferably at least partially surrounds at least a portion of the substrate. The non-parallel portion and at least one of the substrate and superstrate are preferably configured to leave at least a region of the non-parallel portion exposed. The substrate is preferably arranged between (sandwiched between) at least the first radiative region and the ground plane during use of the antenna.

The present invention also provides a method of manufacturing a contactless feed patch antenna as described herein, the method including the steps of:
providing a generally planar first conductive sheet provided as a ground plane;
providing a second conductive sheet as a radiative element, wherein the second conductive sheet is pre-configured as
   a generally planar first radiative region arranged substantially parallel with the first conductive sheet, and
   a second radiative region including a non-parallel portion arranged to be non-parallel with the first radiative region;
moulding a substrate so that the pre-configured radiative element is mounted thereon.

The moulding step may include the step of moulding the substrate so that at least a region of the non-parallel portion remains exposed.

The method may further include, subsequent to the moulding step, a step of removing a portion of the substrate to expose at least a region of the non-parallel portion. The method may further include, subsequent to the moulding step, a step of removing a portion of the substrate to thin the substrate in a portion of the substrate in the region of the non-parallel portion to adjust the response of the antenna.

The method may further include the step of arranging a superstrate to sandwich at least the first radiative region between the superstrate and the moulded substrate. The method may further include the step of arranging the ground plane and at least the first radiative element to sandwich the moulded substrate therebetween.

The method may further include the step of folding the second radiative region so that the non-parallel portion is non-parallel with the first radiative region. The method may further include the step of arranging the first radiative region to be substantially parallel with the first conductive sheet.

Any feature of any aspect or embodiment may be incorporated into any other aspect or embodiment unless the incorporation is expressly forbidden or is understood by the skilled person to be technically impossible.

### BRIEF DESCRIPTION OF THE DRAWINGS

Embodiments of the invention will now be described by way of example with reference to the accompanying drawings in which:

FIG. 1 shows an embodiment of a contactless feed patch antenna according to an aspect a disclosed embodiment of the present invention;

FIG. 2 shows a contactless pin feed incorporated into a patch antenna according to an aspect of a disclosed embodiment of the present invention;

FIG. 3 shows on the left hand side, the simplified component parts of an antenna element and pin feed together with a substrate and superstrate, and shows on the right hand upper side an antenna element arranged with both the substrate and superstrate, and shows on the right hand lower side an antenna element arranged with only the substrate, in accordance with embodiments of the present invention;

FIG. 4A shows a dielectric body fully encapsulating an antenna element in accordance with an embodiment of the present invention;

FIG. 4B shows a dielectric body only partially encapsulating an antenna element in accordance with an embodiment of the present invention; and

FIG. 5 shows an antenna element according to an aspect of the present invention incorporating tab elements useful when folding the antenna element into the desired shape.

### DETAILED DESCRIPTION OF EMBODIMENTS

The general features of an embodiment of the present invention will now be described before they are discussed in more detail.

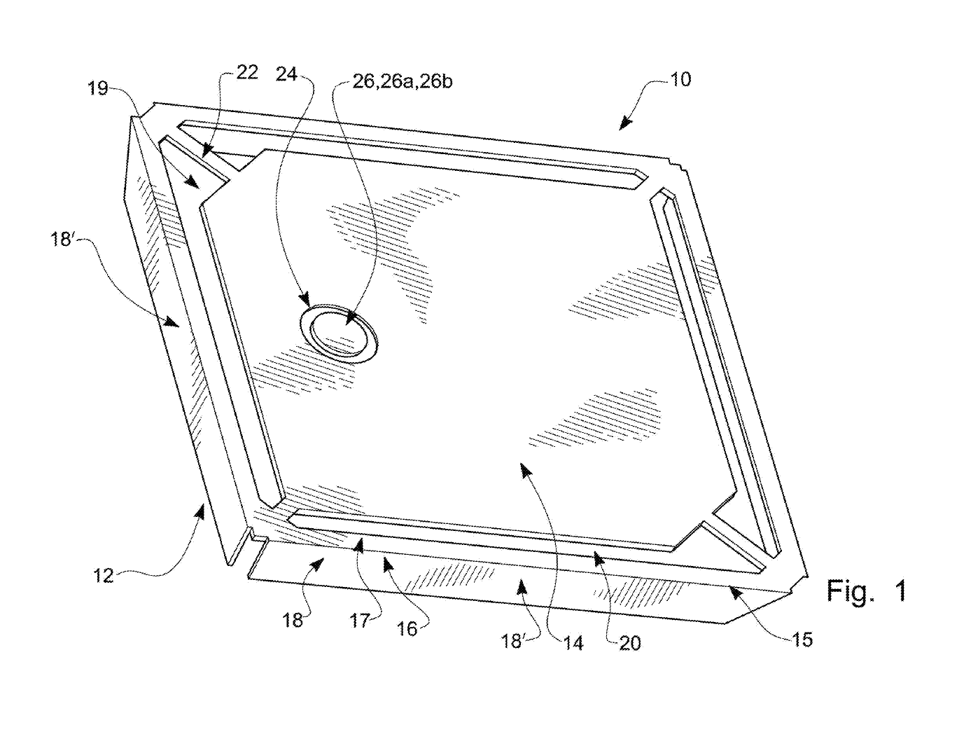

A contactless feed patch antenna 10 according to an aspect of the present invention, as shown in FIG. 1, includes an antenna element 12 formed of a generally planar first radiative region 14, and a second radiative region 16. The second radiative region 16 is preferably formed laterally outwards of the first radiative region 14. For example, the second radiative region 16 may be formed outward of the perimeter of the first radiative region 14. At least a portion of the second radiative region 16 may be formed around the perimeter of the first radiative region 14

In use, the generally planar first radiative region 14 is arranged parallel to a generally planar ground element (not shown) which is configured to act as a ground plane. In other words, the planes in which the first radiative region 14 and the ground element are respectively provided may be parallel planes.

The second radiative region 16 may include a parallel portion 17 which is provided in a plane which is parallel to the plane in which the first radiative region 14 is provided. For example, the parallel portion 17 may be coplanar with the first radiative region 14, as shown in FIG. 1.

The second radiative region 16 includes a non-parallel portion 18 which is provided in a plane which is non-parallel to the plane in which the first radiative region 14 is provided. The non-parallel portion 18 may be folded out of the plane in which the parallel portion 17 is provided for example.

By providing the non-parallel portion 18, the footprint of the patch antenna can be kept small relative to prior art designs, and the beamwidth can be enhanced for better performance at low elevation angles. To maintain an overall compact size for the antenna, it is preferred that the non-parallel portion 18 extends generally towards, rather than away, from the ground element.

In the embodiment shown in FIG. 1, the first and second radiative regions 14 and 16 are partly mutually separated by non-conducting regions 20. Typically, this is achieved by providing a gap between the first and second radiative regions 14 and 16, i.e. by physically separating the first and second radiative regions 14 and 16 at least partially. In this way, the antenna 10 can be made into a multi-band, e.g. a dual band, antenna.

Currently, patch antennas are typically employed for reception and transmission of GPS [i.e. right-hand-circular-polarization (RHCP) waves] and SDARS [i.e. left-hand-circular-polarization (LHCP) waves]. Patch antennas may be considered to be a single element antenna that incorporates performance characteristics of dual element antennas. SDARS, for example, offer digital radio service covering a large geographic area, such as North America. Satellite-based digital audio radio services generally employ either geo-stationary orbit satellites or highly elliptical orbit satellites that receive uplinked programming, which, in turn, is re-broadcasted directly to digital radios in vehicles on the ground that subscribe to the service. SDARS also use terrestrial repeater networks via ground-based towers using different modulation and transmission techniques in urban areas to supplement the availability of satellite broadcasting service by terrestrially broadcasting the same information. The reception of signals from ground-based broadcast stations is termed as terrestrial coverage. Hence, an SDARS antenna is required to have satellite and terrestrial coverage with reception quality determined by the service providers, and each vehicle subscribing to the digital service generally includes a digital radio having a receiver and one or more antennas for receiving the digital broadcast.

GPS (GNSS) antennas, on the other hand, have a broad hemispherical coverage with a maximum antenna gain at the zenith (i.e. hemispherical coverage includes signals from 0° elevation at the earth's surface to signals from 90° elevation up at the sky). Although other types of antennas for GPS and SDARS are available, patch antennas are preferred for GPS and SDARS applications because of their ease to receive circular polarization without additional electronics.

Thus, the first radiative region 14 is preferably provided generally in the form of a quadrilateral and the first radiative region may have each corner, of a pair of diagonally opposite corners, chamfered to facilitate reception of left hand circularly polarized radiation.

The non-parallel portion 18 may be formed of one or more sub-portions 18′. The sub-portions 18′ may cooperate to form a structured arrangement referred to as the non-parallel portion 18. Each sub-portion 18′ preferably extends generally towards, rather than away from the ground element. The sub-portions 18′ may cooperate with the first radiative region to at least partially define a void between the antenna element 12 and the ground element. As discussed elsewhere herein, a dielectric substrate may be provided in the void.

Where the first radiative region 14 is provided as a quadrilateral (e.g. with at least two chamfered corners 19), such as a square or rectangle, a respective sub-portion 18′ may be provided for each side of the quadrilateral. For example, four sub-portions 18′ may be provided.

The pair of adjacent sub-portions 18′ located at a chamfered corner of the first radiative region 14 are obliquely truncated in the region of the chamfered corner. Whereas, the pair of adjacent sub-portions 18′ located at a non-chamfered corner of the first radiative region 14 are preferably not obliquely truncated in the region of the non-chamfered corner. The pair of adjacent sub-portions 18′ located at a non-chamfered corner of the first radiative region 14, may therefore approach each other in a right angled manner. This arrangement facilitates the reception of right hand circularly polarized radiation.

It has been found that the provision of the non-parallel portion 18 of the second radiative region 16 improves the beamwidth of the antenna at low elevation angles for all bands receivable by the multi-band, e.g. deal band, patch antenna.

Bridging elements 22 are provided to put the first and second radiative elements 14, 16 into direct electrical connection. Preferably, the bridging elements 22 are provided at the corners of the first radiative region 14. The bridging elements 22 may be coplanar with the first radiative region and/or the parallel portion 17.

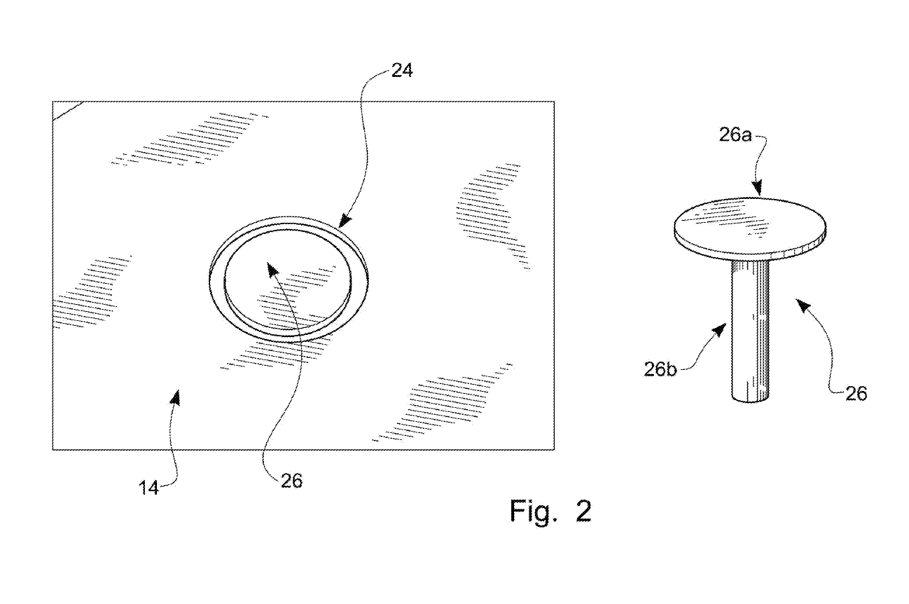

Preferably, the antenna element 12 includes a void 24 formed in the first radiative region 14, as shown in FIG. 2. A pin feed 26 formed of a pin head 26a and a pin leg 26 is coaxially arranged with the void so as to be capacitively coupled to the first radiative region 14. The pin feed 26 and the first radiative region 14 are nonetheless physically separated. For example, the pin head 26a may be arranged in the void, e.g. to be coplanar with the first radiative region 14, whilst being separated from the first radiative region 14 by a gap around the perimeter of the pin head 26a. The gap may be a radial gap. The gap preferably provides a separation of between 0.5 and 3 mm in size.

The pin head 26a may be offset relative to the void so as not to be coplanar with the first radiative region. Such an offset may be referred to as an axial offset. The pin head 26a may, however, be provided in a plane which is parallel with the plane in which the first radiative region 14 is provided. Preferably, the pinhead 26a is arranged relative to the void such that a uniform radial gap is provided between pin head 26a and the first radiative region.

Nevertheless, received signals are capacitively communicated from the first radiative region 14 to the pin feed 26. Advantageously, the capacitive effect produced by the pin feed 26 being located proximate to the void 24 can be exploited to cancel out inductance effects, to allow for perfect imaginary matching (50 ohm+j0) of the feed pin. This is particularly useful where the antenna element 12 is mounted on a dielectric substrate for example, because dielectric substrates can introduce significant inductances affecting the impedance matching of the overall circuit including the pin feed 26.

Also, the dimensions of the pin feed 26 can affect the inductance, and therefore the impedance. In particular, the dimensions of the pin leg 26b affect the inductance. Therefore, the length of the pin leg 26b can be selected to tune the impedance, by adjusting the inductance in view of the capacitive coupling of the pin feed 26 to the first radiative region 14.

Further, from a manufacturing point of view, the (capacitively) coupled feed is advantageous because it removes the need to form a solder connection between the pin feed and the antenna element 12.

In embodiments, the antenna element 12 is mounted on a dielectric substrate 30. Preferably, the substrate is formed of a moulded plastic. The antenna element 12 may be formed from a stamped metal sheet, e.g. as a suitably shaped planar sheet.

The substrate 30 may be moulded to a desired shape. The planar antenna element 12 may then be conformed to the substrate 30, for example by folding the non-parallel portion 18 to conform to the substrate 30, thereby providing an antenna element 12 according to an aspect of the present invention. Preferably, the sub-portions 18′ are arranged on the lateral faces of the substrate 30.

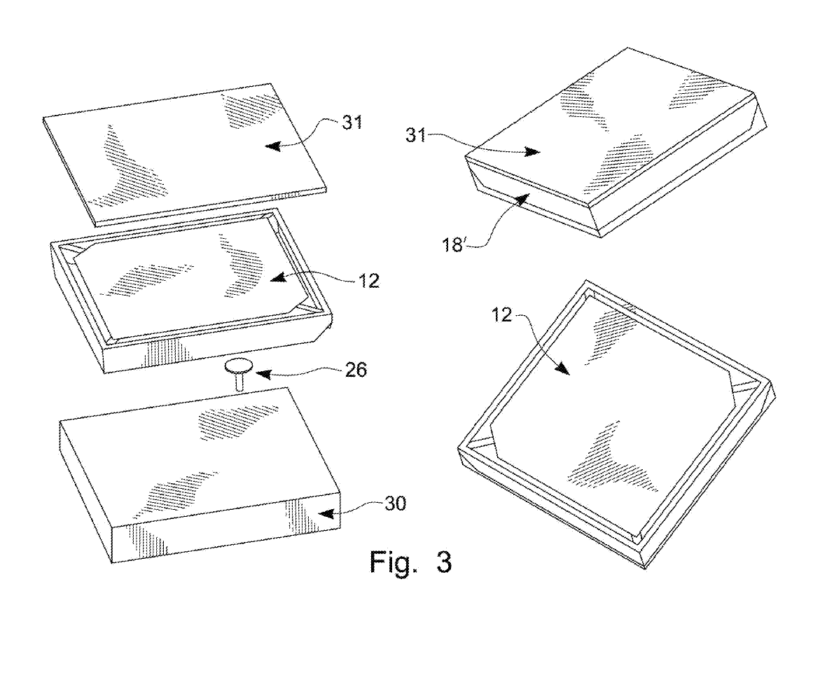

A superstrate 31 may be provided atop the antenna element 12. An exploded, simplified view, of the component parts of such an assembly are shown in FIG. 3.

In embodiments, the antenna element 12 is fully or partly embedded within a dielectric body 32. This arrangement can be thought of as the antenna element 12 being arranged between a substrate 30 and a superstrate 31, for example such that at least the first radiative region 14 is sandwiched between the substrate and superstrate.

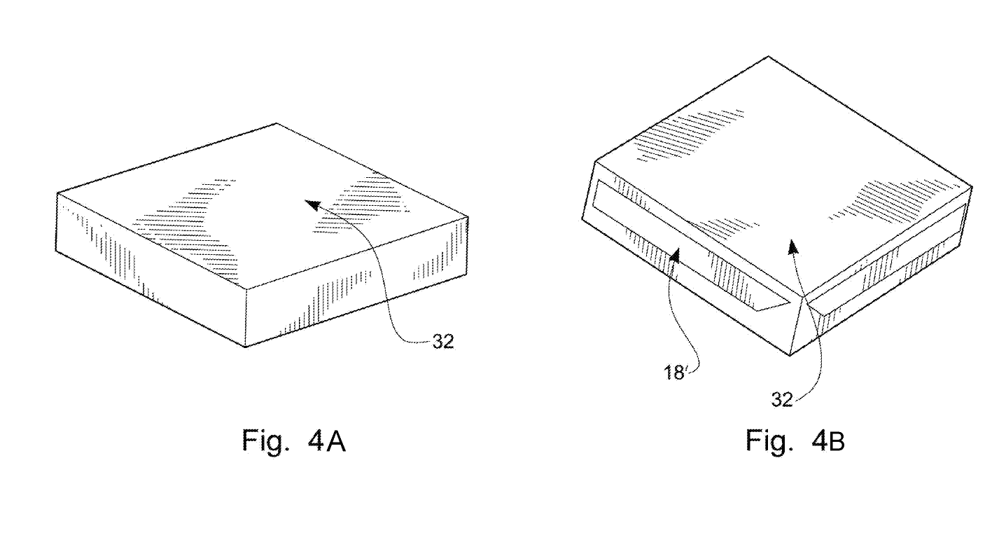

However, in practice, it is expected that the dielectric body 32 will be a single (integral) moulded body, fully or partially encapsulating the antenna element 12. For example, as shown in FIG. 4A, the dielectric body 32 may fully encapsulate the antenna element 12, such that the antenna element 12 is fully embedded within the dielectric body 32 and no portion of the antenna element 12 is exposed.

Another embodiment shown in FIG. 4B demonstrates that at least the non-parallel portion 18, e.g. each sub-portion 18′, may not be encapsulated by (i.e. may not be fully embedded in) the dielectric body 32. The non-parallel portion 18 may thus be exposed. Exposure of the non-parallel portion 18 may be a result of the process of moulding the dielectric body 32 around the antenna element 12. Or, it may be the result of a removal step, whereby one or more portions of the dielectric body 32 is removed (after moulding of the dielectric body) to expose the non-parallel portion 18.

In other embodiments (not shown), the removal step does not result in exposure of the non-parallel portion 18 of the antenna element 18, but merely results in a thinning of the dielectric body 32 in desired regions, for example to tune the response of the resulting antenna into which the modified (thinned) dielectric body 32 and antenna element 12 are incorporated.

At least the pin leg 26b of the pin feed 26 extends through the substrate 30 (or dielectric body 32) to allow the pin feed 26 to be capacitively coupled to the antenna element 12, e.g. to the first radiative region 14. A suitable dielectric material has a relative permittivity of between 6 and 7, preferably 6.15.

The second region 16 may include a relatively narrow parallel portion 17, which is provided in a plane parallel with the plane in which the first radiative region 14 is provided. For example, the parallel portion 17 may be coplanar with the first radiative region 14.

The parallel portion 17 may be useful when deforming the non-parallel portion 18 into a plane which is non-parallel with the plane in which the first radiative region 14 is provided. The deformation may simply be achieved by folding each sub-portion 18 out of their original plane for example. By folding each sub-portion 18′ out of their original plane, the sub-portions 18′ can be arranged to form a skirt extending around and away from the first radiative region.

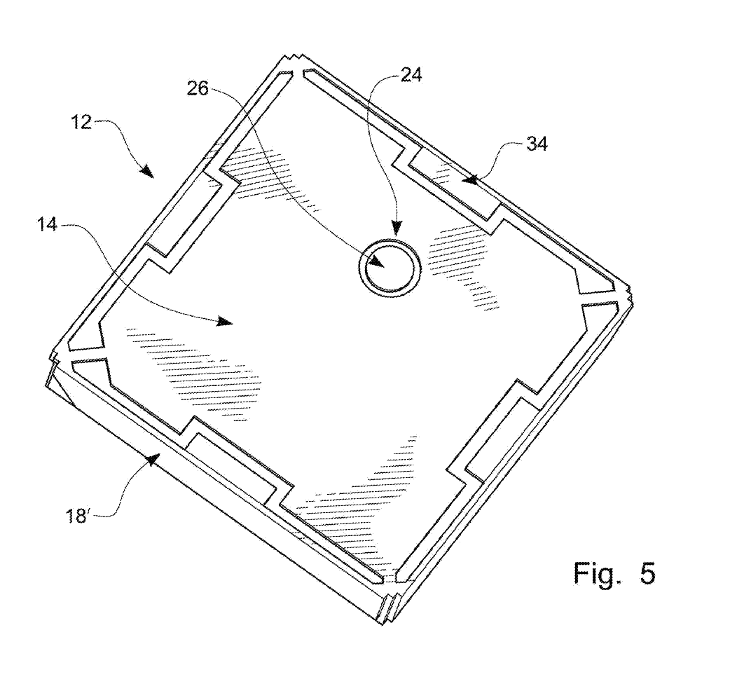

To help facilitate the folding, each sub-portion 18′ may be provided with a respective tab element 34 as shown in FIG. 5. As the each sub-portion 18′ is folded out of its original plane, the respective tab element can provide a means for restraining and preventing deformation of the parallel portion 17 adjacent the sub-portion 18′. The first radiative region 14 may be shaped to accommodate suitably the dimensioned tab elements 34.

A patch antenna according to the present invention is preferably an antenna adapted to receive radio frequency signals. For example, to receive signals in the Ultra High Frequency (UHF) range, such as between 1.5 GHz and 1.6 GHz.

What is claimed is:

1. A contactless feed patch antenna comprising:
a generally planar first conductive sheet provided as a ground plane;
a second conductive sheet provided as a radiative element, the second conductive sheet including
a generally planar first radiative region arranged substantially parallel with the first conductive sheet, and
a second radiative region including a non-parallel portion arranged in a non-parallel plane to that of the first radiative region.

2. The contactless feed patch antenna according to claim 1, wherein the second radiative region is arranged at or outward of the periphery of the first radiative region.

3. The contactless feed patch antenna according to claim 1, wherein the non-parallel portion extends partway between the first radiative region and the ground plane.

4. The contactless feed patch antenna according to claim 1, wherein one or more non-conducting regions are provided in the second conductive sheet between the first radiative region and the second radiative region, such that the patch antenna is configured to be operable as a multi-band patch antenna.

5. The contactless feed patch antenna according to claim 4, wherein the one or more non-conducting regions are provided as one or more slits in the second conductive sheet.

6. The contactless feed patch antenna according to claim 1, wherein the second radiative region includes a parallel portion arranged to be parallel with the first radiative region.

7. The contactless feed patch antenna according to claim 6, wherein the second radiative region includes a fold provided between the parallel portion and the non-parallel portion.

8. The patch antenna according to claim 7, wherein the non-parallel portion includes a plurality of sub-portions, each arranged around a respective side of the perimeter of the first radiative region.

9. The contactless feed patch antenna according to claim 8, wherein
the first radiative region is provided in the general form of a quadrilateral in which each corner, of a pair of diagonally opposing corners of the quadrilateral, is chamfered; and
a pair of adjacent sub-portions are each chamfered so as to cooperate to define a chamfered region of the non-parallel portion, the chamfered region being associated with one of the chamfered corners of the first radiative region.

10. The contactless feed patch antenna according to claim 1, wherein the first and second radiative regions are electrically connected by at least one bridging element.

11. The contactless feed patch antenna according to claim 9, wherein
each corner of the first radiative element is electrically connected to a corresponding corner region of the second radiative element by a bridging element; and
each chamfered corner of the first radiative element is electrically connected to a corresponding chamfered region of the second radiative element.

12. The contactless feed patch antenna according to claim 1, wherein the first radiative region is formed to define a void therein, and a correspondingly shaped electric feed element is provided within the void to be physically separate from, but capacitively coupled to, the first radiative region.

13. The contactless feed patch antenna according to claim 1, wherein at least the first radiative region of the generally planar second conductive sheet is mounted on a substrate.

14. The contactless feed patch antenna according to claim 13, wherein at least the first radiative region is arranged between the substrate and a molded superstrate.

15. The contactless feed patch antenna according to claim 13, wherein the non-parallel portion at least partially surrounds at least a portion of the substrate.

16. The contactless feed patch antenna according to claim 2, wherein the non-parallel portion extends partway between the first radiative region and the ground plane.

17. The contactless feed patch antenna according to claim 2, wherein one or more non-conducting regions are provided in the second conductive sheet between the first radiative region and the second radiative region, such that the patch antenna is configured to be operable as a multi-band patch antenna.

18. The contactless feed patch antenna according to claim 3, wherein one or more non-conducting regions are provided in the second conductive sheet between the first radiative region and the second radiative region, such that the patch antenna is configured to be operable as a multi-band patch antenna.

19. The contactless feed patch antenna according to claim 2, wherein the second radiative region includes a parallel portion arranged to be parallel with the first radiative region.

20. The contactless feed patch antenna according to claim 3, wherein the second radiative region includes a parallel portion arranged to be parallel with the first radiative region.
